(19) United States
(12) Patent Application Publication
(10) Pub. No.: US 2022/0007420 A1
(43) Pub. Date: Jan. 6, 2022

(54) SPREADING ASPECTS OF RANDOM ACCESS CHANNEL PROCEDURE

(71) Applicant: QUALCOMM Incorporated, San Diego, CA (US)

(72) Inventors: Ahmed Abdelaziz Ibrahim Abdelaziz ZEWAIL, San Diego, CA (US); Xiaoxia ZHANG, San Diego, CA (US); Tao LUO, San Diego, CA (US); Qiang WU, San Diego, CA (US); Jun MA, San Diego, CA (US); Iyab Issam SAKHNINI, San Diego, CA (US); Mehmet Izzet GURELLI, San Diego, CA (US); Anantha Krishna Karthik NAGARAJAN, San Diego, CA (US); Jing SUN, San Diego, CA (US); Juan MONTOJO, San Diego, CA (US); Peter GAAL, San Diego, CA (US)

(21) Appl. No.: 17/305,065

(22) Filed: Jun. 30, 2021

Related U.S. Application Data
(60) Provisional application No. 63/046,928, filed on Jul. 1, 2020.

(51) Int. Cl. H04W 74/08

(52) U.S. Cl. CPC H04W 74/0833

(57) ABSTRACT

Various aspects of the present disclosure generally relate to wireless communication. In some aspects, a user equipment may receive, from a base station, a random access configuration indicating spreading code information for a set of random access channel (RACH) occasions associated with a RACH procedure, and transmit, to the base station, a physical RACH communication in a RACH occasion, of the set of RACH occasions, using a spreading code, wherein the spreading code is determined based at least in part on the spreading code information. Numerous other aspects are provided.

### CROSS-REFERENCE TO RELATED APPLICATION

This Patent application claims priority to U.S. Provisional Patent Application No. 63/046,928, filed on Jul. 1, 2020, entitled “SPREADING ASPECTS OF RANDOM ACCESS CHANNEL PROCEDURE,” and assigned to the assignee hereof. The disclosure of the prior Application is considered part of and is incorporated by reference into this Patent Application.

### FIELD OF THE DISCLOSURE

Aspects of the present disclosure generally relate to wireless communication and to techniques and apparatuses for spreading aspects of a random access channel (RACH) procedure.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include a number of base stations (BSs) that can support communication for a number of user equipment (UEs). A UE may communicate with a BS via the downlink and uplink. “Downlink” (or “forward link”) refers to the communication link from the BS to the UE, and “uplink” (or “reverse link”) refers to the communication link from the UE to the BS. As will be described in more detail herein, a BS may be referred to as a Node B, a gNB, an access point (AP), a radio head, a transmit receive point (TRP), a New Radio (NR) BS, a 5G Node B, or the like.

The above multiple access technologies have been adopted in various telecommunication standards to provide a common protocol that enables different user equipment to communicate on a municipal, national, regional, and even global level. NR, which may also be referred to as 5G, is a set of enhancements to the LTE mobile standard promulgated by the 3GPP. NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some aspects, a method of wireless communication performed by a user equipment (UE) includes: receiving, from a base station, a random access configuration indicating spreading code information for a set of random access channel (RACH) occasions associated with a RACH procedure; and transmitting, to the base station, a physical RACH (PRACH) communication in a RACH occasion, of the set of RACH occasions, using a spreading code, wherein the spreading code is determined based at least in part on the spreading code information.

In some aspects, a method of wireless communication performed by a base station includes: transmitting, to one or more UEs, a random access configuration indicating spreading code information for a set of RACH occasions associated with a RACH procedure; and receiving, from a UE of the one or more UEs, a PRACH communication in a RACH occasion, of the set of RACH occasions, using a spreading code, wherein the spreading code is determined based at least in part on the spreading code information.

In some aspects, a UE for wireless communication includes: a memory; and one or more processors coupled to the memory, the one or more processors configured to: receive, from a base station, a random access configuration indicating spreading code information for a set of RACH occasions associated with a RACH procedure; and transmit, to the base station, a PRACH communication in a RACH occasion, of the set of RACH occasions, using a spreading code, wherein the spreading code is determined based at least in part on the spreading code information.

In some aspects, a base station for wireless communication includes: a memory; and one or more processors coupled to the memory, the one or more processors configured to: transmit, to one or more UEs, a random access configuration indicating spreading code information for a set of RACH occasions associated with a RACH procedure; and receive, from a UE of the one or more UEs, a PRACH communication in a RACH occasion, of the set of RACH occasions, using a spreading code, wherein the spreading code is determined based at least in part on the spreading code information.

In some aspects, a non-transitory computer-readable medium storing a set of instructions for wireless communication includes: one or more instructions that, when executed by one or more processors of a UE, cause the UE to: receive, from a base station, a random access configuration indicating spreading code information for a set of RACH occasions associated with a RACH procedure; and transmit, to the base station, a PRACH communication in a RACH occasion, of the set of RACH occasions, using a spreading code, wherein the spreading code is determined based at least in part on the spreading code information.

In some aspects, a non-transitory computer-readable medium storing a set of instructions for wireless communication includes: one or more instructions that, when executed by one or more processors of a base station, cause the base station to: transmit, to one or more UEs, a random access configuration indicating spreading code information for a set of RACH occasions associated with a RACH procedure; and receive, from a UE of the one or more UEs, a PRACH communication in a RACH occasion, of the set of RACH occasions, using a spreading code, wherein the spreading code is determined based at least in part on the spreading code information.

In some aspects, an apparatus for wireless communication includes: means for receiving, from a base station, a random access configuration indicating spreading code information for a set of RACH occasions associated with a RACH procedure; and means for transmitting, to the base station, a PRACH communication in a RACH occasion, of the set of RACH occasions, using a spreading code, wherein the spreading code is determined based at least in part on the spreading code information.

In some aspects, an apparatus for wireless communication includes: means for transmitting, to one or more UEs, a random access configuration indicating spreading code information for a set of RACH occasions associated with a RACH procedure; and means for receiving, from a UE of the one or more UEs, a PRACH communication in a RACH occasion, of the set of RACH occasions, using a spreading code, wherein the spreading code is determined based at least in part on the spreading code information.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, or artificial intelligence-enabled devices). Aspects may be implemented in chip-level components, modular components, non-modular components, non-chip-level components, device-level components, or system-level components. Devices incorporating described aspects and features may include additional components and features for implementation and practice of claimed and described aspects. For example, transmission and reception of wireless signals may include a number of components for analog and digital purposes (e.g., hardware components including antennas, radio frequency (RF) chains, power amplifiers, modulators, buffers, processor(s), interleavers, adders, or summers). It is intended that aspects described herein may be practiced in a wide variety of devices, components, systems, distributed arrangements, or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of a two-step random access procedure, in accordance with the present disclosure.

FIG. 4 is a diagram illustrating an example of a four-step random access procedure, in accordance with the present disclosure.

FIG. 5 is a diagram illustrating an example of a random access signal configuration including multiple repetitions of a physical random access channel (RACH) sequence in time, in accordance with the present disclosure.

FIG. 6 is a diagram illustrating an example associated with capability reporting for a RACH procedure, in accordance with the present disclosure.

FIG. 7 is a diagram illustrating an example associated with spreading aspects of a RACH procedure, in accordance with the present disclosure.

FIGS. 8-9 are diagrams illustrating example processes associated with spreading aspects of a RACH procedure, in accordance with the present disclosure.

FIGS. 10-11 are diagrams illustrating example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with a 5G or NR radio access technology (RAT), aspects of the present disclosure can be applied to other RATs, such as a 3G RAT, a 4G RAT, and/or a RAT subsequent to 5G (e.g., 6G).

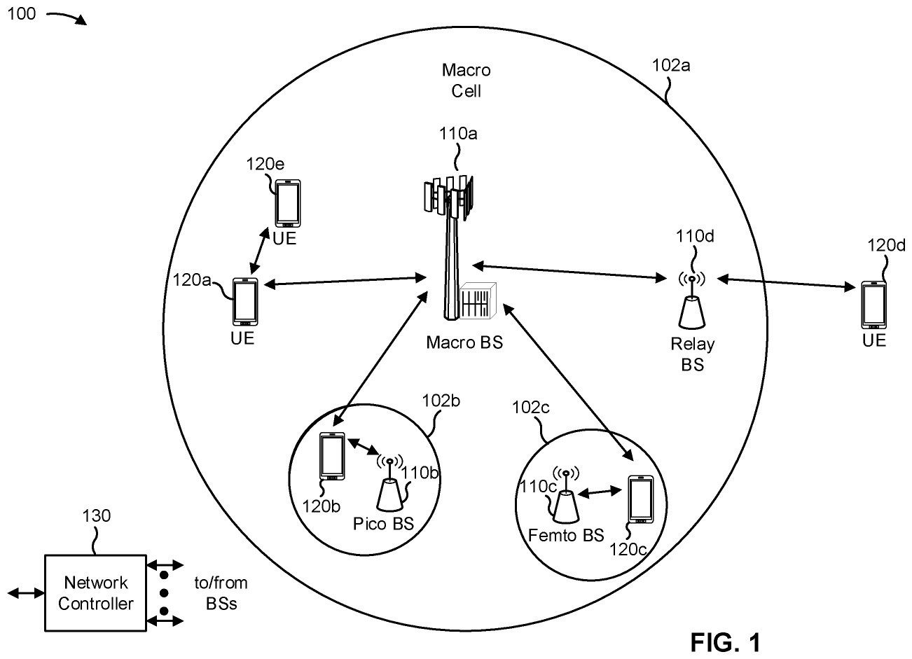

FIG. 1 is a diagram illustrating an example of a wireless network 100, in accordance with the present disclosure. The wireless network 100 may be or may include elements of a 5G (NR) network and/or an LTE network, among other examples. The wireless network 100 may include a number of base stations 110 (shown as BS 110a, BS 110b, BS 110c, and BS 110d) and other network entities. A base station (BS) is an entity that communicates with user equipment (UEs) and may also be referred to as an NR BS, a Node B, a gNB, a 5G node B (NB), an access point, a transmit receive point (TRP), or the like. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). ABS for a macro cell may be referred to as a macro BS. ABS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB”, “base station”, “NR BS”, “gNB”, “TRP”, “AP”, “node B”, “5G NB”, and “cell” may be used interchangeably herein.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces, such as a direct physical connection or a virtual network, using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay BS 110d may communicate with macro BS 110a and a UE 120d in order to facilitate communication between BS 110a and UE 120d. A relay BS may also be referred to as a relay station, a relay base station, a relay, or the like.

Wireless network 100 may be a heterogeneous network that includes BSs of different types, such as macro BSs, pico BSs, femto BSs, relay BSs, or the like. These different types of BSs may have different transmit power levels, different coverage areas, and different impacts on interference in wireless network 100. For example, macro BSs may have a high transmit power level (e.g., 5 to 40 watts) whereas pico BSs, femto BSs, and relay BSs may have lower transmit power levels (e.g., 0.1 to 2 watts).

A network controller 130 may couple to a set of BSs and may provide coordination and control for these BSs. Network controller 130 may communicate with the BSs via a backhaul. The BSs may also communicate with one another, directly or indirectly, via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, and/or location tags, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a Customer Premises Equipment (CPE). UE 120 may be included inside a housing that houses components of UE 120, such as processor components and/or memory components. In some aspects, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks may be deployed in a given geographic area. Each wireless network may support a particular RAT and may operate on one or more frequencies. A RAT may also be referred to as a radio technology, an air interface, or the like. A frequency may also be referred to as a carrier, a frequency channel, or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol or a vehicle-to-infrastructure (V2I) protocol), and/or a mesh network. In this case, the UE 120 may perform scheduling operations, resource selection operations, and/or other operations described elsewhere herein as being performed by the base station 110.

Devices of wireless network 100 may communicate using the electromagnetic spectrum, which may be subdivided based on frequency or wavelength into various classes, bands, channels, or the like. For example, devices of wireless network 100 may communicate using an operating band having a first frequency range (FR1), which may span from 410 MHz to 7.125 GHz, and/or may communicate using an operating band having a second frequency range (FR2), which may span from 24.25 GHz to 52.6 GHz. The frequencies between FR1 and FR2 are sometimes referred to as mid-band frequencies. Although a portion of FR1 is greater than 6 GHz, FR1 is often referred to as a “sub-6 GHz” band. Similarly, FR2 is often referred to as a “millimeter wave” band despite being different from the extremely high frequency (EHF) band (30 GHz-300 GHz) which is identified by the International Telecommunications Union (ITU) as a “millimeter wave” band. Thus, unless specifically stated otherwise, it should be understood that the term “sub-6 GHz” or the like, if used herein, may broadly represent frequencies less than 6 GHz, frequencies within FR1, and/or mid-band frequencies (e.g., greater than 7.125 GHz). Similarly, unless specifically stated otherwise, it should be understood that the term “millimeter wave” or the like, if used herein, may broadly represent frequencies within the EHF band, frequencies within FR2, and/or mid-band frequencies (e.g., less than 24.25 GHz). It is contemplated that the frequencies included in FR1 and FR2 may be modified, and techniques described herein are applicable to those modified frequency ranges.

As indicated above, FIG. 1 is provided as an example. Other examples may differ from what is described with regard to FIG. 1.

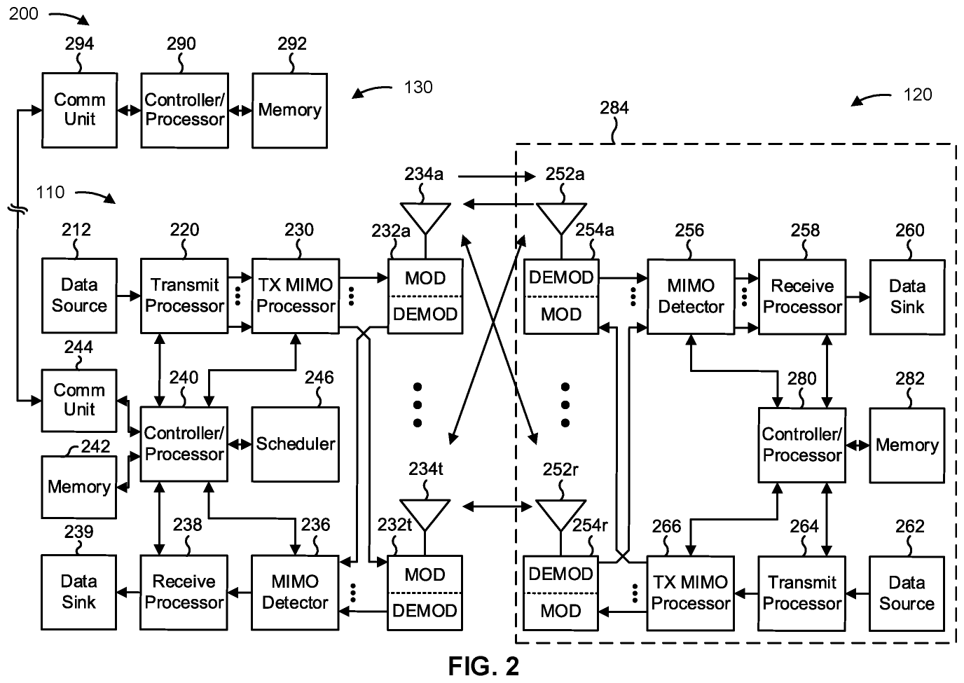

FIG. 2 is a diagram illustrating an example 200 of a base station 110 in communication with a UE 120 in a wireless network 100, in accordance with the present disclosure. Base station 110 may be equipped with T antennas 234a through 234t, and UE 120 may be equipped with R antennas 252a through 252r, where in general T≥1 and R≥1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI)) and control information (e.g., CQI requests, grants, and/or upper layer signaling) and provide overhead symbols and control symbols. Transmit processor 220 may also generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (Mods) 232a through 232t. Each modulator 232 may process a respective output symbol stream (e.g., for OFDM) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a channel quality indicator (CQI) parameter, among other examples. In some aspects, one or more components of UE 120 may be included in a housing 284.

Network controller 130 may include communication unit 294, controller/processor 290, and memory 292. Network controller 130 may include, for example, one or more devices in a core network. Network controller 130 may communicate with base station 110 via communication unit 294.

Antennas (e.g., antennas 234a through 234t and/or antennas 252a through 252r) may include, or may be included within, one or more antenna panels, antenna groups, sets of antenna elements, and/or antenna arrays, among other examples. An antenna panel, an antenna group, a set of antenna elements, and/or an antenna array may include one or more antenna elements. An antenna panel, an antenna group, a set of antenna elements, and/or an antenna array may include a set of coplanar antenna elements and/or a set of non-coplanar antenna elements. An antenna panel, an antenna group, a set of antenna elements, and/or an antenna array may include antenna elements within a single housing and/or antenna elements within multiple housings. An antenna panel, an antenna group, a set of antenna elements, and/or an antenna array may include one or more antenna elements coupled to one or more transmission and/or reception components, such as one or more components of FIG. 2.

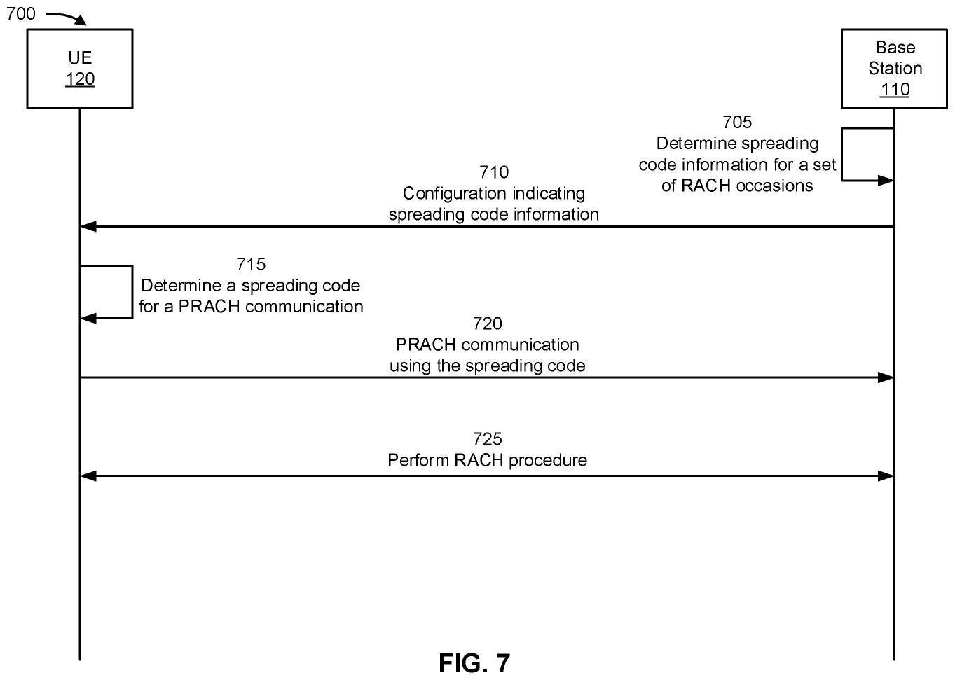

On the uplink, at UE 120, a transmit processor 264 may receive and process data from a data source 262 and control information (e.g., for reports that include RSRP, RSSI, RSRQ, and/or CQI) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM or CP-OFDM), and transmitted to base station 110. In some aspects, a modulator and a demodulator (e.g., MOD/DEMOD 254) of the UE 120 may be included in a modem of the UE 120. In some aspects, the UE 120 includes a transceiver. The transceiver may include any combination of antenna(s) 252, modulators and/or demodulators 254, MIMO detector 256, receive processor 258, transmit processor 264, and/or TX MIMO processor 266. The transceiver may be used by a processor (e.g., controller/processor 280) and memory 282 to perform aspects of any of the methods described herein (for example, as described with reference to FIGS. 7-9).

At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Base station 110 may include a scheduler 246 to schedule UEs 120 for downlink and/or uplink communications. In some aspects, a modulator and a demodulator (e.g., MOD/DEMOD 232) of the base station 110 may be included in a modem of the base station 110. In some aspects, the base station 110 includes a transceiver. The transceiver may include any combination of antenna(s) 234, modulators and/or demodulators 232, MIMO detector 236, receive processor 238, transmit processor 220, and/or TX MIMO processor 230. The transceiver may be used by a processor (e.g., controller/processor 240) and memory 242 to perform aspects of any of the methods described herein (for example, as described with reference to FIGS. 7-9).

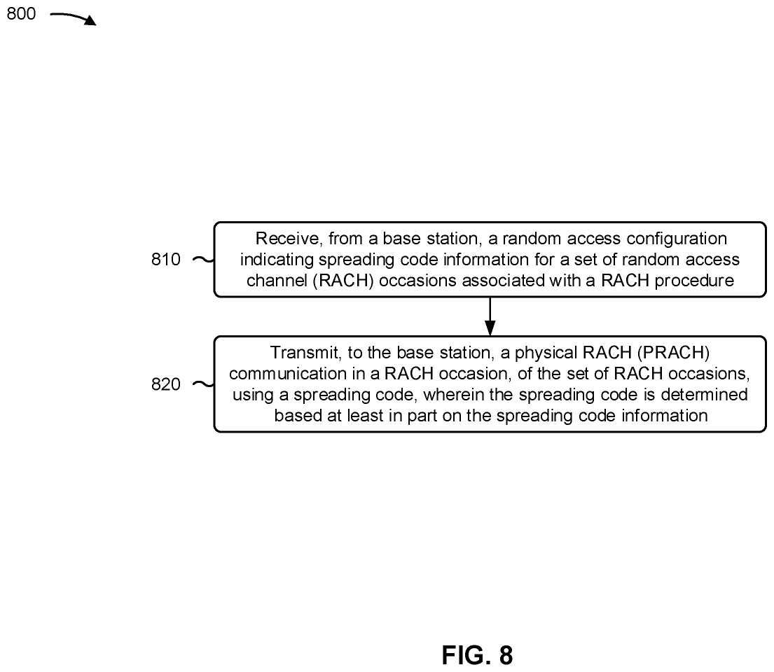

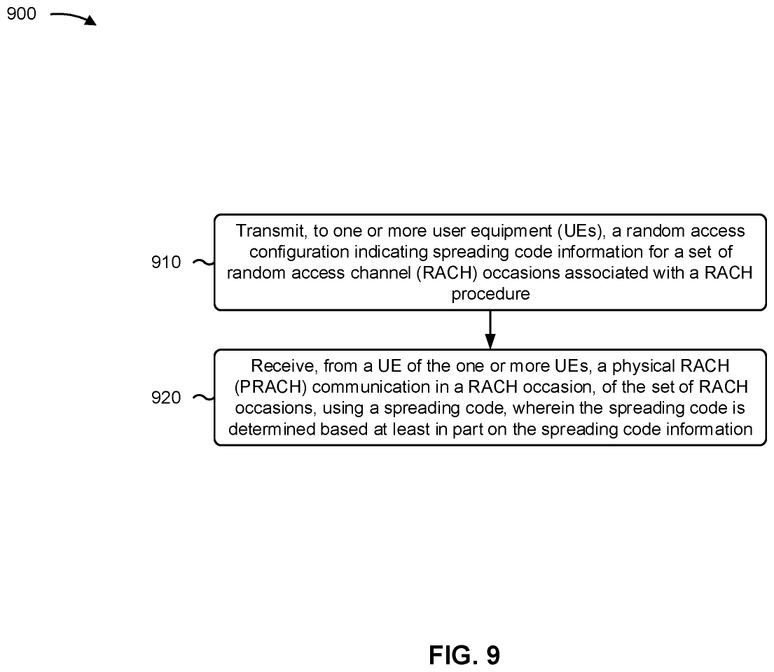

Controller/processor 240 of base station 110, controller/processor 280 of UE 120, and/or any other component(s) of FIG. 2 may perform one or more techniques associated with spreading aspects of a RACH procedure, as described in more detail elsewhere herein. For example, controller/processor 240 of base station 110, controller/processor 280 of UE 120, and/or any other component(s) of FIG. 2 may perform or direct operations of, for example, process 800 of FIG. 8, process 900 of FIG. 9, and/or other processes as described herein. Memories 242 and 282 may store data and program codes for base station 110 and UE 120, respectively. In some aspects, memory 242 and/or memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 800 of FIG. 8, process 900 of FIG. 9, and/or other processes as described herein. In some aspects, executing instructions may include running the instructions, converting the instructions, compiling the instructions, and/or interpreting the instructions, among other examples.

In some aspects, UE 120 may include means for receiving, from a base station, a random access configuration indicating spreading code information for a set of RACH occasions associated with a RACH procedure; and/or means for transmitting, to the base station, a physical RACH (PRACH) communication in a RACH occasion, of the set of RACH occasions, using a spreading code, wherein the spreading code is determined based at least in part on the spreading code information among other examples. In some aspects, such means may include one or more components of UE 120 described in connection with FIG. 2, such as controller/processor 280, transmit processor 264, TX MIMO processor 266, MOD 254, antenna 252, DEMOD 254, MIMO detector 256, receive processor 258, and/or the like.

In some aspects, base station 110 may include means for transmitting, to one or more UEs, a random access configuration indicating spreading code information for a set of RACH occasions associated with a RACH procedure; and/or means for receiving, from a UE of the one or more UEs, a PRACH communication in a RACH occasion, of the set of RACH occasions, using a spreading code, wherein the spreading code is determined based at least in part on the spreading code information; among other examples. In some aspects, such means may include one or more components of base station 110 described in connection with FIG. 2, such as antenna 234, DEMOD 232, MIMO detector 236, receive processor 238, controller/processor 240, transmit processor 220, TX MIMO processor 230, MOD 232, antenna 234, and/or the like.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of controller/processor 280.

As indicated above, FIG. 2 is provided as an example. Other examples may differ from what is described with regard to FIG. 2.

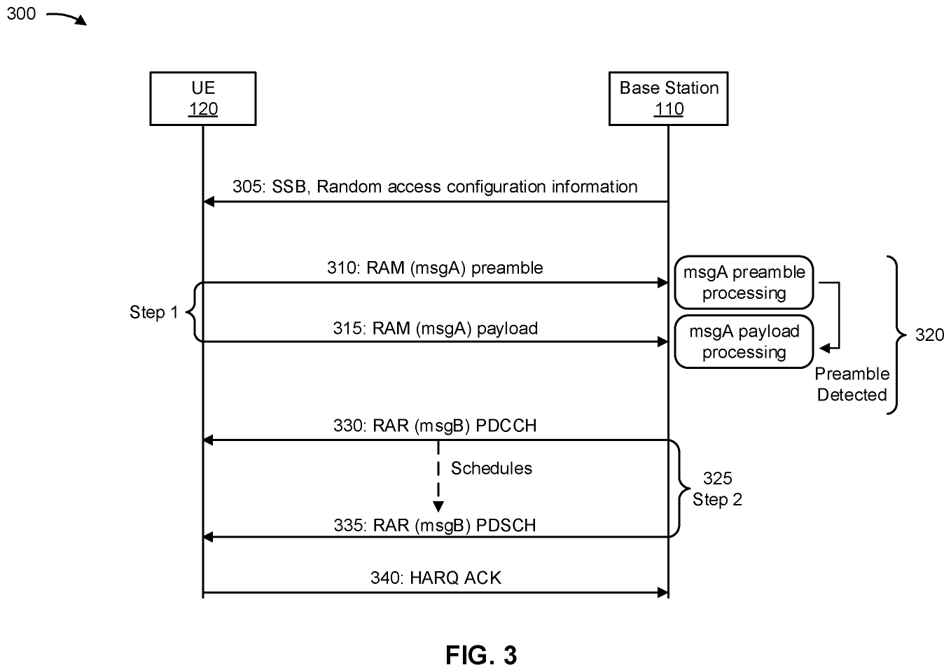

FIG. 3 is a diagram illustrating an example 300 of a two-step random access procedure, in accordance with the present disclosure. As shown in FIG. 3, a base station 110 and a UE 120 may communicate with one another to perform the two-step random access procedure.

As shown by reference number 305, the base station 110 may transmit, and the UE 120 may receive, one or more synchronization signal blocks (SSBs) and random access configuration information. In some aspects, the random access configuration information may be transmitted in and/or indicated by system information (e.g., in one or more system information blocks (SIBs)) and/or an SSB, such as for contention-based random access. Additionally, or alternatively, the random access configuration information may be transmitted in a radio resource control (RRC) message and/or a physical downlink control channel (PDCCH) order message that triggers a RACH procedure, such as for contention-free random access. The random access configuration information may include one or more parameters to be used in the two-step random access procedure, such as one or more parameters for transmitting a random access message (RAM), receiving a random access response (RAR) to the RAM, and/or the like.

As shown by reference number 310, the UE 120 may transmit, and the base station 110 may receive, a RAM preamble. As shown by reference number 315, the UE 120 may transmit, and the base station 110 may receive, a RAM payload. As shown, the UE 120 may transmit the RAM preamble and the RAM payload to the base station 110 as part of an initial (or first) step of the two-step random access procedure. In some aspects, the RAM may be referred to as message A, msgA, a first message, an initial message, and/or the like in a two-step random access procedure. Furthermore, in some aspects, the RAM preamble may be referred to as a message A preamble, a msgA preamble, a preamble, a physical random access channel (PRACH) preamble, and/or the like, and the RAM payload may be referred to as a message A payload, a msgA payload, a payload, and/or the like. In some examples, the RAM may include some or all of the contents of message 1 (msg1) and message 3 (msg3) of a four-step random access procedure, which is described in more detail below. For example, the RAM preamble may include some or all contents of message 1 (e.g., a PRACH preamble), and the RAM payload may include some or all contents of message 3 (e.g., a UE identifier, uplink control information (UCI), a physical uplink shared channel (PUSCH) transmission, and/or the like).

As shown by reference number 320, the base station 110 may receive the RAM preamble transmitted by the UE 120. If the base station 110 successfully receives and decodes the RAM preamble, the base station 110 may then receive and decode the RAM payload.

As shown by reference number 325, the base station 110 may transmit an RAR (sometimes referred to as an RAR message). As shown, the base station 110 may transmit the RAR message as part of a second step of the two-step random access procedure. In some examples, the RAR message may be referred to as message B, msgB, or a second message in a two-step random access procedure. The RAR message may include some or all of the contents of message 2 (msg2) and message 4 (msg4) of a four-step random access procedure. For example, the RAR message may include the detected PRACH preamble identifier, the detected UE identifier, a timing advance value, and/or contention resolution information, among other examples.

As shown by reference number 330, as part of the second step of the two-step random access procedure, the base station 110 may transmit a PDCCH communication for the RAR. The PDCCH communication may schedule a physical downlink shared channel (PDSCH) communication that includes the RAR. For example, the PDCCH communication may indicate a resource allocation (e.g., in downlink control information (DCI)) for the PDSCH communication.

As shown by reference number 335, as part of the second step of the two-step random access procedure, the base station 110 may transmit the PDSCH communication for the RAR, as scheduled by the PDCCH communication. The RAR may be included in a medium access control (MAC) protocol data unit (PDU) of the PDSCH communication. As shown by reference number 340, if the UE 120 successfully receives the RAR, the UE 120 may transmit a hybrid automatic repeat request (HARD) acknowledgement (ACK).

As indicated above, FIG. 3 is provided as an example. Other examples may differ from what is described with regard to FIG. 3.

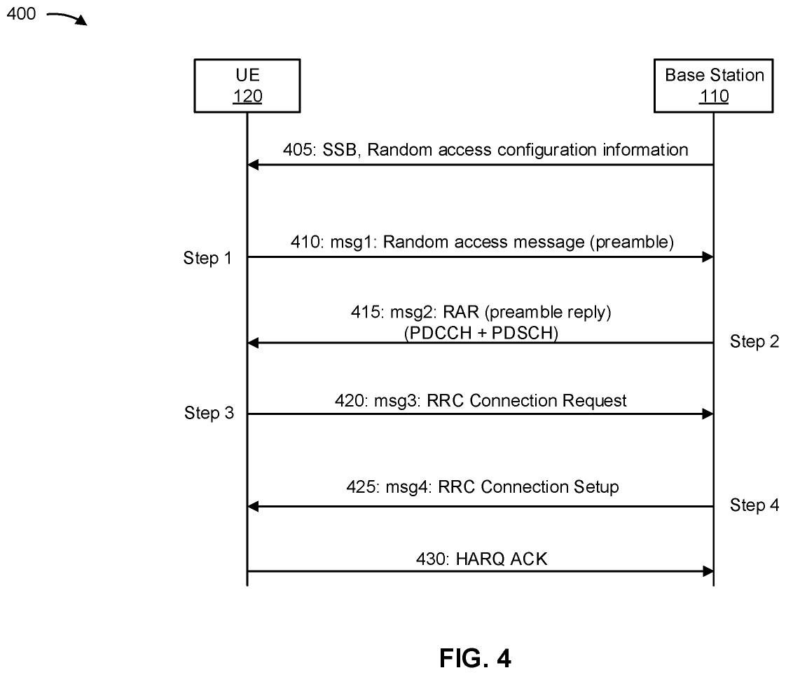

FIG. 4 is a diagram illustrating an example of a four-step random access procedure, in accordance with the present disclosure. As shown in FIG. 4, a base station 110 and a UE 120 may communicate with one another to perform the four-step random access procedure.

As shown by reference number 405, the base station 110 may transmit, and the UE 120 may receive, one or more SSBs and random access configuration information. In some aspects, the random access configuration information may be transmitted in and/or indicated by system information (e.g., in one or more system information blocks (SIBs)) and/or an SSB, such as for contention-based random access. Additionally, or alternatively, the random access configuration information may be transmitted in an RRC message and/or a PDCCH order message that triggers a RACH procedure, such as for contention-free random access. The random access configuration information may include one or more parameters to be used in the random access procedure, such as one or more parameters for transmitting a RAM, one or more parameters for receiving an RAR, and/or the like.

As shown by reference number 410, the UE 120 may transmit a RAM, which may include a preamble (sometimes referred to as a random access preamble, a PRACH preamble, and/or a RAM preamble). The message that includes the preamble may be referred to as a message 1, msg1, MSG1, a first message, an initial message, and/or the like in a four-step random access procedure. The random access message may include a random access preamble identifier.

As shown by reference number 415, the base station 110 may transmit an RAR as a reply to the preamble. The message that includes the RAR may be referred to as message 2, msg2, MSG2, or a second message in a four-step random access procedure. In some aspects, the RAR may indicate the detected random access preamble identifier (e.g., received from the UE 120 in msg1). Additionally, or alternatively, the RAR may indicate a resource allocation to be used by the UE 120 to transmit message 3 (msg3).

In some aspects, as part of the second step of the four-step random access procedure, the base station 110 may transmit a PDCCH communication for the RAR. The PDCCH communication may schedule a PDSCH communication that includes the RAR. For example, the PDCCH communication may indicate a resource allocation for the PDSCH communication. Also as part of the second step of the four-step random access procedure, the base station 110 may transmit the PDSCH communication for the RAR, as scheduled by the PDCCH communication. The RAR may be included in a MAC PDU of the PDSCH communication.

As shown by reference number 420, the UE 120 may transmit an RRC connection request message. The RRC connection request message may be referred to as message 3, msg3, MSG3, or a third message of a four-step random access procedure. In some aspects, the RRC connection request may include a UE identifier, UCI, a PUSCH communication (e.g., an RRC connection request), and/or the like.

As shown by reference number 425, the base station 110 may transmit an RRC connection setup message. The RRC connection setup message may be referred to as message 4, msg4, MSG4, or a fourth message of a four-step random access procedure. In some aspects, the RRC connection setup message may include the detected UE identifier, a timing advance value, contention resolution information, and/or the like. As shown by reference number 430, if the UE 120 successfully receives the RRC connection setup message, the UE 120 may transmit a HARQ ACK.

As indicated above, FIG. 4 is provided as an example. Other examples may differ from what is described with regard to FIG. 4.

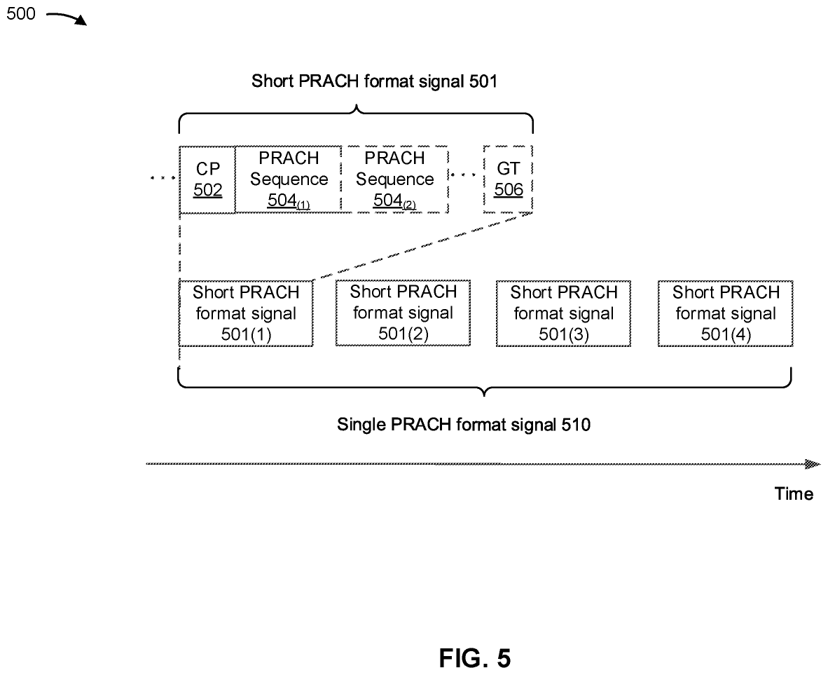

FIG. 5 is a diagram illustrating an example 500 of a random access signal configuration including multiple repetitions of a physical random access channel (RACH) sequence in time, in accordance with the present disclosure. The configuration may be employed by a base station 110 and a UE 120 in a wireless network (e.g., wireless network 100). In particular, a base station 110 may employ the configuration to configure a PRACH format signal to facilitate network access.

In the example illustrated in FIG. 5, the UE 120 may transmit a single PRACH format signal 510 including multiple repetitions of a short PRACH format signal 501 with scaled numerology. The short PRACH format signal 501 may correspond to the RAM preamble (e.g., the PRACH preamble) in FIGS. 3 and 4. The short PRACH format signal 501 includes a cyclic prefix (CP) 502 followed by one or more PRACH sequences 504, with or without a guard time (GT) 506. In some examples, if the short PRACH format signal 501 is a PRACH format A signal, the short PRACH format signal 501 may not have the GT 506. In that case, each repetition of the multiple repetitions may include a CP 502 and one or more PRACH sequences 504 (e.g., without the GT 506). If the short PRACH format signal 501 is a PRACH format B signal or a PRACH format C signal, the short PRACH format signal 501 may have the GT 506. In that case, each repetition of the multiple repetitions may include a CP 502, one or more PRACH sequences 504, and a GT 506.

The UE 120 may transmit the single PRACH format signal 510 in a frequency band, where the single PRACH format signal 510 includes a length in time that is based at least in part on a subcarrier spacing (SCS) in the frequency band. The single PRACH format signal 510 may be longer than the short PRACH format signal 501 and may include multiple repetitions of the short PRACH format signal 501 during the length in time. Although the single PRACH format signal 510 is shown as including four repetitions of the short PRACH format signal 501, this is not intended to be limiting, and fewer than or more than four repetitions may be included in other examples of a single PRACH format signal 510 that the UE 120 transmits to the base station 110. The number of repetitions may vary depending on the PRACH format, the symbol duration, and/or signal coverage requirement. In some aspects, the single PRACH format signal 510 may include multiple repetitions of the short PRACH format signal 501 where different repetitions of the short PRACH format signal 501 have different formats.

In some examples, the single PRACH format signal 510 may include an aggregation of the multiple repetitions of the short PRACH format signal 501 with scaled numerology. For example, the UE 120 may aggregate the multiple repetitions of the short PRACH format signal 501 into the single PRACH format signal 510 and may repeat each of the short PRACH format signals 501 in time to compensate for a loss in the coverage (e.g., due to a shorter symbol duration associated with a larger SCS of a frequency band).

In some examples, the single PRACH format signal 510 may include multiple repetitions of the short PRACH format signal 501 with scaled numerology based at least in part on a spreading code. The UE 120 may spread the multiple repetitions of the short PRACH format signal 501 over time by repeating the short PRACH format signal 501 in time and applying the spreading code to the multiple repetitions. For example, the spreading code may be [1, 1, 1, 1], and the UE 120 may apply the spreading code to the short PRACH format signal 501(1), the short PRACH format signal 501(2), the short PRACH format signal 501(3), and the short PRACH format signal 501(4), respectively. In this example, the UE 120 may multiply the short PRACH format signal 501(1) by 1, multiply the short PRACH format signal 501(2) by 1, multiply the short PRACH format signal 501(3) by 1, and multiply the short PRACH format signal 501(4) by 1. In another example, the spreading code may be [1, −1, 1, −1], and the UE 120 may apply the spreading code to the short PRACH format signal 501(1), the short PRACH format signal 501(2), the short PRACH format signal 501(3), and the short PRACH format signal 501(4), respectively. In this example, the UE 120 may multiply the short PRACH format signal 501(1) by 1, multiply the short PRACH format signal 501(2) by (−1), multiply the short PRACH format signal 501(3) by 1, and multiply the short PRACH format signal 501(4) by (−1).

The spreading with the spreading code may allow two UEs 120 to transmit the same signal PRACH format signal 510 (e.g., four repetitions of the short PRACH format signal 501) using the same resource, but applying a different spreading code (e.g., orthogonal to each other). Accordingly, the base station 110 may differentiate the two single PRACH format signals 510 transmitted by the two different UEs 120.

In some examples, the UE 120 may apply aggregation and/or spreading to the multiple repetitions of the short PRACH format signal 501 (e.g., PRACH format A signal, PRACH format B signal, or PRACH format C signal). For example, the UE 120 may further apply spreading on top of the aggregation of multiple repetitions of the short PRACH format signal 501. Similarly, the UE 120 may apply aggregation and/or spreading over multiple RACH occasions (e.g., each short PRACH format signal 501 may occupy a single RACH occasion).

As indicated above, FIG. 5 is provided as an example. Other examples may differ from what is described with respect to FIG. 5.

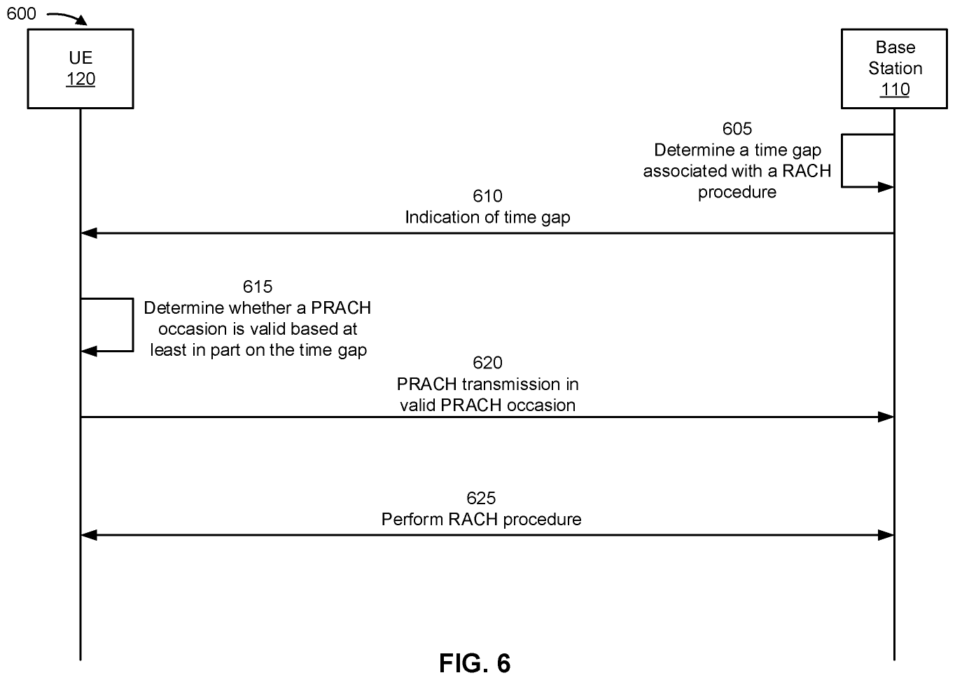

FIG. 6 is a diagram illustrating an example 600 associated with capability reporting for a RACH procedure, in accordance with the present disclosure. As shown in FIG. 6, a base station 110 and a UE 120 may communicate with one another in a wireless network (e.g., wireless network 100).

As show by reference number 605, the base station 110 may determine a time gap value associated with a RACH procedure based at least in part on a capability of the base station 110. The time gap value may be based at least in part on an amount of time the base station 110 needs to switch between transmitting an SSB and receiving a PRACH transmission. The capability of the base station 110 may be a full duplex capability of the base station 110, a spatial diversity, at the base station, of a transmit beam and a receive beam for one or more RACH resources, and/or the like. For example, the base station 110 may support full duplex communication (e.g., the base station 110 may be capable of receiving and transmitting at the same time). As a result, the base station 110 may need little or no time between transmitting an SSB and receiving a PRACH transmission.

The base station 110 may determine that a RACH resource has sufficient spatial diversity such that the base station 110 may need little or no time between transmitting an SSB and receiving a PRACH transmission. For example, an SSB transmit beam and a PRACH receive beam for a specific RACH resource may have sufficient separation at the base station 110 to allow for little or no time between transmitting an SSB and receiving a PRACH transmission (e.g., the SSB transmit beam and the PRACH receive beam may be separated such that there is no or little interference between the SSB transmit beam and the PRACH receive beam).

In some aspects, the base station 110 may determine that the time gap value associated with the RACH procedure that is based at least in part on the capability of the base station 110 is different than a stored or pre-configured time gap value associated with the RACH procedure. For example, the base station 110 and/or the UE 120 may be pre-configured with a time gap value or have a stored time gap value for the RACH procedure. The stored or pre-configured time gap value may be based at least in part on (e.g., defined, or otherwise fixed, by) a wireless communication standard, such as a 3GPP Technical Specification (e.g., an Ngap value defined by 3GPP T.S. 38.213). The stored or pre-configured time gap value may not consider or may not be based at least in part on a capability of the base station 110. The base station 110 may determine that the time gap value that is based at least in part on the capability of the base station 110 is different than (or less than) a stored or pre-configured time gap value associated with the RACH procedure.

As shown by reference number 610, the base station 110 may transmit an indication of the time gap value associated with the RACH procedure, based at least in part on determining the time gap value associated with the RACH procedure. The base station 110 may transmit the indication of the time gap value associated with the RACH procedure using Layer 1 signaling, Layer 2 signaling, RRC signaling, and/or broadcast signaling, among other examples. In some examples, the indication of the time gap value associated with the RACH procedure may be included in random access configuration information that is transmitted by the base station 110. In some aspects, the base station 110 may configure a SIB to include the indication of the time gap value associated with the RACH procedure. The base station 110 may transmit the SIB including the indication of the time gap value associated with the RACH procedure.

The UE 120 may receive the indication of the time gap value associated with the RACH procedure that is based at least in part on a capability of the base station. The UE 120 may determine one or more (or all) RACH resources that are associated with the time gap value based at least in part on the indication of the time gap value associated with the RACH procedure.

As shown by reference number 615, the UE 120 may determine whether a RACH occasion associated with the RACH procedure is valid based at least in part on receiving the indication of the time gap value associated with the RACH procedure. For example, the UE 120 may determine a stored or pre-configured time gap value associated with the RACH procedure (e.g., the stored or pre-configured time gap value that is based at least in part on a wireless communication standard discussed above). The UE 120 may refrain from using the stored or pre-configured time gap value associated with the RACH procedure when determining whether the PRACH occasion associated with the RACH procedure is valid based at least in part on receiving the indication of the time gap value associated with the RACH procedure. That is, the UE 120 may replace the stored or pre-configured time gap value with the time gap value indicated by the base station 110 when determining whether a PRACH occasion associated with the RACH procedure is valid.

For example, the UE 120 may determine a starting symbol associated with a transmission opportunity associated with the RACH procedure (e.g., a PRACH occasion). The UE 120 may determine an ending symbol (e.g., a last symbol) of a last received SSB (e.g., the most recently received SSB). The UE 120 may determine whether a quantity of symbols between the ending symbol of the last received SSB and the starting symbol associated with the PRACH occasion satisfies the time gap value (e.g., indicated by the base station 110).

As shown by reference number 620, the UE 120 may selectively transmit, to the base station 110, a PRACH transmission in the PRACH occasion based at least in part on determining whether the PRACH occasion is valid. That is, if the UE 120 determines that the PRACH occasion is valid, the UE 120 may transmit the PRACH transmission in the PRACH occasion. If the UE 120 determines that the PRACH occasion is not valid, the UE 120 may not transmit the PRACH transmission in the PRACH occasion. In some aspects, the PRACH transmission may be a PRACH preamble associated with the RACH procedure. The base station 110 may selectively receive the PRACH transmission in the PRACH occasion in a similar manner as described above.

As shown by reference number 625, the base station 110 and the UE 120 may perform the RACH procedure using valid PRACH occasions (e.g., determined using the time gap value that is based at least in part on the capability of the base station 110). For example, the base station 110 and the UE 120 may perform a two-step RACH procedure (e.g., as described above with respect to FIG. 3), a four-step RACH procedure (e.g., as described above with respect to FIG. 4), and/or the like.

As a result, RACH occasions that would have otherwise been wasted (e.g., determined to be invalid by the UE 120 using the stored or pre-configured time gap value) may be utilized by the UE 120 and the base station 110 associated with a RACH procedure. This improves network performance by enabling the UE 120 to transmit in more RACH occasions than if the UE 120 were to determine valid RACH occasions without considering the capability of the base station 110.

As indicated above, FIG. 6 is provided as an example. Other examples may differ from what is described with respect to FIG. 6.

In some wireless networks, UEs may be configured to apply a spreading code to a PRACH transmission, as described above with respect to FIG. 5. In some cases, certain UEs may not be capable of receiving and/or decoding a signal from a base station to overwrite a time gap value associated with a RACH procedure, such as the signal described above with respect to FIG. 6. Additionally, certain UEs may not be capable of transmitting during the RACH occasions which are now valid based at least in part on the time gap value indicated by the base station 110 (e.g., as described above with respect to FIG. 6). As a result, certain RACH occasions may be valid for some, but not all, UEs in a network. This may cause spreading over all RACH occasions to fail as orthogonality cannot be maintained when certain RACH occasions are considered invalid for some UEs in a network while valid for other UEs in the network. Therefore, a base station may be unable to differentiate two PRACH transmissions sent by two different UEs 120 using the same resource.

Some techniques and apparatuses described herein enable spreading aspects for a RACH procedure to be applied when certain RACH occasions are considered invalid for some UEs in a network while valid for other UEs in the network. For example, a base station may configure a UE to apply a spreading code among RACH occasions that are valid for all UEs in the network, a spreading code among RACH occasions that are valid based at least in part on the time gap value indicated by the base station 110 (e.g., as described above with respect to FIG. 6), a spreading code among RACH occasions that are valid for UEs that are capable of receiving and/or decoding the signal from a base station to overwrite a time gap value associated with a RACH procedure, and/or the like. As a result, spreading may be applied over multiple RACH occasions where certain RACH occasions are considered invalid for some UEs in a network while valid for other UEs in the network. Applying spreading to PRACH transmissions improves coverage of PRACH transmissions by aggregating multiple repetitions of a PRACH preamble into a single PRACH transmission. Additionally, a base station is enabled to differentiate two PRACH transmissions sent by two different UEs 120 using the same resource when spreading is applied to the PRACH transmissions with orthogonality maintained.

FIG. 7 is a diagram illustrating an example 700 associated with spreading aspects of a RACH procedure, in accordance with the present disclosure. As shown in FIG. 7, a base station 110 and a UE 120 may communicate with one another in a wireless network (e.g., wireless network 100).

As show by reference number 705, the base station 110 may determine spreading code information for a set of RACH occasions associated with the RACH procedure. The base station 110 may determine the spreading code information based at least in part on a validity of RACH occasions, included in the set of RACH occasions, for a set of UEs associated with the base station. For example, the set of RACH occasions may include a subset of RACH occasions that are valid for all UEs 120 associated with the base station 110 (e.g., based at least in part on a pre-configured or stored time gap value, as described above with respect to FIG. 6). The set of RACH occasions may include a subset of RACH occasions that are valid for a proper subset of UEs 120 associated with the base station 110 (e.g., based at least in part on time gap value indicated by the base station 110, as described above with respect to FIG. 6). For example, the set of RACH occasions may include RO1, RO2, RO3, RO4, and RO5. In some aspects, RO1, RO3, and RO5 may be valid for all UEs 120 associated with the base station 110 (e.g., based at least in part on a pre-configured or stored time gap value). RO2 and RO4 may be determined to be valid (e.g., by a UE 120) only if using the time gap value indicated by the base station 110 (e.g., as described above with respect to FIG. 6).

In some aspects, the UE 120 may have a RACH capability. The RACH capability may be a capability of the UE 120 to receive and/or decode a signal from the base station 110 indicating the time gap value (e.g., as described above with respect to FIG. 6). In some aspects, the RACH capability may be a capability of the UE 120 to transmit during a RACH occasion which is valid based at least in part on the time gap value indicated by the base station 110. For example, a RACH occasion which is valid based at least in part on the time gap value indicated by the base station 110 may occur shortly after, or directly after, an SSB is received by the UE 120. Therefore, in some aspects, the RACH capability of the UE 120 may be a full duplex capability (e.g., a capability to receive and transmit at the same time), and/or a capability of the UE 120 to determine to not receive the SSB and to transmit during the RACH occasion, among other examples.

The base station 110 may determine that the spreading code information should indicate a spreading code for a first subset of RACH occasions, of the set of RACH occasions, that are valid for each UE of the set of UEs 120 associated with the base station. In some aspects, the base station 110 may determine that the spreading code information should indicate a spreading code for a second subset of RACH occasions, of the set of RACH occasions, that are valid only for a subset of UEs 120 of the set of UEs 120 associated with the base station (e.g., UEs 120 that include the RACH capability). In some aspects, the base station 110 may determine that the spreading code information should indicate a spreading code for a third subset of RACH occasions, of the set of RACH occasions, that are valid for the subset of UEs 120 of the set of UEs 120 associated with the base station. Therefore, using the example above where the set of RACH occasions include RO1, RO2, RO3, RO4, and RO5 (e.g., where RO2 and RO4 are valid only for UEs 120 that include the RACH capability), the base station 110 may determine a spreading code to be applied among RO1, RO3, and RO5 (e.g., the RACH occasions that are valid for all UEs 120) for all UEs 120 associated with the base station 110. In some aspects, the spreading code to be applied among RO1, RO3, and RO5 may be for UEs 120 that do not include the RACH capability (e.g., UEs 120 that include the RACH capability may not apply this spreading code). The base station 110 may determine a spreading code to be applied among RO2 and RO4 (e.g., the RACH occasions that are valid only for UEs 120 that include the RACH capability) for the UEs 120 that include the RACH capability. The base station 110 may determine a spreading code to be applied among RO1, RO2, RO3, RO4, and RO5, but only for UEs 120 that include the RACH capability (e.g., UEs 120 that do not include the RACH capability may not receive an indication of this spreading code, may not apply this spreading code, and/or the like).

In some aspects, the base station 110 may determine a spreading code to be applied by a UE 120 to PRACH communications based at least in part on a quantity of repetitions of a PRACH preamble included in the PRACH communications. For example, the base station 110 may configure the spreading code information to indicate that if the quantity of repetitions of a PRACH preamble included in a PRACH communication is an even value, a first spreading code is to be applied to the PRACH communication. The base station 110 may configure the spreading code information to indicate that if the quantity of repetitions of a PRACH preamble included in a PRACH communication is an odd value, a second spreading code is to be applied to the PRACH communication. In some aspects, the first spreading code may be a Walsh code (e.g., a Hadamard code, a Walsh family code, a Walsh-Hadamard code, and/or the like). In some aspects, the second spreading code may be a discrete Fourier transform (DFT) based spreading code.

In some aspects, the base station 110 may determine that a spreading code is to be a nested spreading code. The base station 110 may determine that a spreading code is to be a nested spreading code based at least in part on a quantity of repetitions of a PRACH preamble included in the PRACH communication. In some aspects, the base station 110 may determine that a spreading code is to be a nested spreading code based at least in part on a quantity of repetitions allowed for a PRACH preamble or a subset of PRACH preambles (e.g., based at least in part on a format of the PRACH preamble). For example, base station 110 may configure the spreading code information to indicate that if a quantity of repetitions of a PRACH preamble included in a PRACH communication (or allowed by the PRACH preamble) is an even value then the spreading code to be applied for the PRACH communication is a nested Walsh code.

In some aspects, the base station 110 may determine one or more subsets of PRACH preambles from a set of PRACH preambles associated with the RACH procedure. For example, the base station 110 may determine a subset of PRACH preambles based at least in part on a quantity of repetitions of a PRACH preamble, of the set of PRACH preambles, to be included in PRACH communications. For example, the base station 110 may determine a subset of PRACH preambles associated with even quantities of repetitions, odd quantities of repetitions, and/or the like. The base station 110 may determine a subset of PRACH preambles based at least in part on the RACH capability of UEs 120. For example, the base station 110 may determine a first subset of PRACH preambles for UEs 120 that include the RACH capability and a second subset of PRACH preambles for UEs 120 that do not include the RACH capability. The base station 110 may arrange a random access configuration to indicate the one or more subsets of PRACH preambles.

As shown by reference number 710, the base station 110 may transmit a configuration indicating the spreading code information. The configuration may be a random access configuration for a RACH procedure. For example, the base station 110 may determine the spreading code information, as described above, and arrange the random access configuration to include or indicate the spreading code information. The configuration may indicate the one or more subsets of PRACH preambles. In some aspects, the one or more subsets of PRACH preambles may be indicated to the UE 120 in a different configuration.

As shown by reference number 715, the UE 120 may determine a spreading code to be applied to a PRACH transmission. The UE 120 may receive the configuration, from the base station 110, and may identify the spreading code information. The UE 120 may determine the spreading code to be applied to the PRACH transmission based at least in part on the spreading code information.

For example, the UE 120 may determine a spreading code to be applied to a PRACH transmission based at least in part on the RACH occasion in which the PRACH communication is to be transmitted, a quantity of repetitions of a PRACH preamble included in the PRACH communication, a RACH capability of the UE 120, and/or the like. The UE 120 may determine, from the spreading code information, that the RACH occasion in which the PRACH communication is to be transmitted is associated with a spreading code based at least in part on the RACH occasion being valid for all UEs 120. In some aspects, the UE 120 may include the RACH capability. As a result, the RACH occasion may be a RACH occasion that is valid for only UEs 120 that include the RACH capability. Therefore, the UE 120 may determine a spreading code, from the spreading code information, that is associated with RACH occasions that are valid for only UEs 120 that include the RACH capability.

In some aspects, the UE 120 may determine the spreading code to be applied to a PRACH communication based at least in part on the quantity of repetitions of a PRACH preamble included in the PRACH communication. For example, the spreading code information may indicate that a first spreading code (e.g., a Walsh code) is to be applied if the quantity of repetitions of a PRACH preamble is an even value. The spreading code information may indicate that a second spreading code (e.g., a DFT based spreading code) is to be applied if the quantity of repetitions of a PRACH preamble is an odd value. In some aspects, the UE 120 may determine, from the spreading code information, that the spreading code is a nested spreading code based at least in part on the quantity of repetitions of a PRACH preamble included in the PRACH communication.

As shown by reference number 720, the UE 120 may transmit, to the base station 110, the PRACH communication using the spreading code. For example, the UE 120 may determine the spreading code from the spreading code information, apply the spreading code to the PRACH communication, and transmit the PRACH communication to the base station 110. In some aspects, the PRACH communication may include multiple repetitions of a PRACH preamble, aggregated into a single PRACH communication. In some aspects, the PRACH communication may include PRACH preambles occupying multiple RACH occasions. In some aspects, the PRACH preambles included in the PRACH communication may be different formats.

As shown by reference number 725, the base station 110 and the UE 120 may perform the RACH procedure based at least in part on the transmission of the PRACH communication using the spreading code. For example, the base station 110 and the UE 120 may perform a two-step RACH procedure (e.g., as described above with respect to FIG. 3), and/or a four-step RACH procedure (e.g., as described above with respect to FIG. 4), among other examples.

As a result, spreading may be applied over multiple RACH occasions where certain RACH occasions are considered invalid for some UEs 120 in a network while valid for other UEs 120 in the network. Applying spreading to PRACH transmissions improves coverage of PRACH transmissions by aggregating multiple repetitions of a PRACH preamble into a single PRACH transmission. Additionally, the base station 110 is enabled to differentiate two PRACH transmissions sent by two different UEs 120 using the same resource when spreading is applied to the PRACH transmissions with orthogonality maintained through the spreading codes, as described above.

As indicated above, FIG. 7 is provided as an example. Other examples may differ from what is described with respect to FIG. 7.

FIG. 8 is a diagram illustrating an example process 800 performed, for example, by a UE, in accordance with the present disclosure. Example process 800 is an example where the UE (e.g., UE 120) performs operations associated with spreading aspects of a RACH procedure.

As shown in FIG. 8, in some aspects, process 800 may include receiving, from a base station, a random access configuration indicating spreading code information for a set of RACH occasions associated with a RACH procedure (block 810). For example, the UE (e.g., using receive processor 258, transmit processor 264, controller/processor 280, memory 282, and/or the like) may receive, from a base station, a random access configuration indicating spreading code information for a set of RACH occasions associated with a RACH procedure, as described above.

As further shown in FIG. 8, in some aspects, process 800 may include transmitting, to the base station, a physical RACH (PRACH) communication in a RACH occasion, of the set of RACH occasions, using a spreading code, wherein the spreading code is determined based at least in part on the spreading code information (block 820). For example, the UE (e.g., using receive processor 258, transmit processor 264, controller/processor 280, memory 282, and/or the like) may transmit, to the base station, a PRACH communication in a RACH occasion, of the set of RACH occasions, using a spreading code, as described above. In some aspects, the spreading code is determined based at least in part on the spreading code information.

Process 800 may include additional aspects, such as any single aspect or any combination of aspects described below and/or in connection with one or more other processes described elsewhere herein.

In a first aspect, process 800 includes determining the spreading code associated with the PRACH communication from the spreading code information based at least in part on at least one of the RACH occasion, of the set of RACH occasions, associated with the PRACH communication, a quantity of repetitions of a PRACH preamble included in the PRACH communication, or a RACH capability of the UE.

In a second aspect, alone or in combination with the first aspect, the spreading code information for the set of RACH occasions associated with the RACH procedure indicates at least one of: a first spreading code for a first subset of RACH occasions, of the set of RACH occasions, that are valid for each UE associated with the base station; a second spreading code for a second subset of RACH occasions, of the set of RACH occasions, that are valid only for a proper subset of UEs associated with the base station; or a third spreading code for a third subset of RACH occasions, of the set of RACH occasions, that are valid for the proper subset of UEs associated with the base station.

In a third aspect, alone or in combination with one or more of the first and second aspects, the proper subset of UEs associated with the base station is determined based at least in part on a RACH capability of UEs included in the proper subset of UEs.

In a fourth aspect, alone or in combination with one or more of the first through third aspects, process 800 includes determining, from the spreading code information, the spreading code based at least in part on a quantity of repetitions of a PRACH preamble included in the PRACH communication.

In a fifth aspect, alone or in combination with one or more of the first through fourth aspects, process 800 includes determining, from the spreading code information, that the spreading code is a nested spreading code based at least in part on a quantity of repetitions of a PRACH preamble included in the PRACH communication.

In a sixth aspect, alone or in combination with one or more of the first through fifth aspects, receiving, from the base station, the random access configuration indicating the spreading code information for the set of RACH occasions associated with the RACH procedure comprises receiving, from the base station, the random access configuration indicating a set of PRACH preambles, wherein the set of PRACH preambles include one or more subsets of PRACH preambles.

In a seventh aspect, alone or in combination with one or more of the first through sixth aspects, a subset of PRACH preambles, of the set of PRACH preambles, is associated with a quantity of repetitions of a PRACH preamble included in the PRACH communication, or a RACH capability of the UE.

In an eighth aspect, alone or in combination with one or more of the first through seventh aspects, the one or more subsets of PRACH preambles include a first subset of PRACH preambles associated with a first set of UEs associated with the base station, and a second subset of PRACH preambles associated with a second set of UEs associated with the base station.

In a ninth aspect, alone or in combination with one or more of the first through eighth aspects, the spreading code is a Walsh code, or a discrete Fourier transform based spreading code.

In a tenth aspect, alone or in combination with one or more of the first through ninth aspects, process 800 includes determining that a quantity of repetitions of a PRACH preamble included in the PRACH communication is an even value; and determining that the spreading code is a Walsh code.

In an eleventh aspect, alone or in combination with one or more of the first through tenth aspects, process 800 includes determining that a quantity of repetitions of a PRACH preamble included in the PRACH communication is an odd value; and determining that the spreading code is a discrete Fourier transform based spreading code.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a base station, in accordance with the present disclosure. Example process 900 is an example where the base station (e.g., base station 110) performs operations associated with spreading aspects of a RACH procedure.

As shown in FIG. 9, in some aspects, process 900 may include transmitting, to one or more UEs, a random access configuration indicating spreading code information for a set of RACH occasions associated with a RACH procedure (block 910). For example, the base station (e.g., using transmit processor 220, receive processor 238, controller/processor 240, memory 242, and/or the like) may transmit, to one or more UEs, a random access configuration indicating spreading code information for a set of RACH occasions associated with a RACH procedure, as described above.

As further shown in FIG. 9, in some aspects, process 900 may include receiving, from a UE of the one or more UEs, a PRACH communication in a RACH occasion, of the set of RACH occasions, using a spreading code, wherein the spreading code is determined based at least in part on the spreading code information (block 920). For example, the base station (e.g., using transmit processor 220, receive processor 238, controller/processor 240, memory 242, and/or the like) may receive, from a UE of the one or more UEs, a PRACH communication in a RACH occasion, of the set of RACH occasions, using a spreading code, as described above. In some aspects, the spreading code is determined based at least in part on the spreading code information.

Process 900 may include additional aspects, such as any single aspect or any combination of aspects described below and/or in connection with one or more other processes described elsewhere herein.

In a first aspect, process 900 includes determining the spreading code information for the set of RACH occasions associated with the RACH procedure based at least in part on a validity of RACH occasions, included in the set of RACH occasions, for a set of UEs associated with the base station.

In a second aspect, alone or in combination with the first aspect, determining the spreading code information for the set of RACH occasions associated with the RACH procedure comprises determining at least one of: a first spreading code for a first subset of RACH occasions, of the set of RACH occasions, that are valid for each UE of the set of UEs associated with the base station; a second spreading code for a second subset of RACH occasions, of the set of RACH occasions, that are valid only for a subset of UEs of the set of UEs associated with the base station; or a third spreading code for a third subset of RACH occasions, of the set of RACH occasions, that are valid for the subset of UEs of the set of UEs associated with the base station.

In a third aspect, alone or in combination with one or more of the first and second aspects, process 900 includes determining the subset of UEs, of the set of UEs associated with the base station, based at least in part on a RACH capability of UEs included in the subset of UEs.

In a fourth aspect, alone or in combination with one or more of the first through third aspects, determining the spreading code information for the set of RACH occasions associated with the RACH procedure comprises determining a spreading code to be applied to PRACH communications based at least in part on a quantity of repetitions of a PRACH preamble included in the PRACH communications.

In a fifth aspect, alone or in combination with one or more of the first through fourth aspects, determining the spreading code information for the set of RACH occasions associated with the RACH procedure comprises determining a nested spreading code to be applied to PRACH communications based at least in part on a quantity of repetitions of a PRACH preamble included in the PRACH communications.

In a sixth aspect, alone or in combination with one or more of the first through fifth aspects, process 900 includes determining, from a set of PRACH preambles, one or more subsets of PRACH preambles based at least in part on a quantity of repetitions of a PRACH preamble, of the set of PRACH preambles, to be included in PRACH communications, or a RACH capability of UEs associated with the base station.

In a seventh aspect, alone or in combination with one or more of the first through sixth aspects, determining, from the set of PRACH preambles, the one or more subsets of PRACH preambles comprises determining a first subset of PRACH preambles associated with a first set of UEs associated with the base station, and determining a second subset of PRACH preambles associated with a second set of UEs associated with the base station.

In an eighth aspect, alone or in combination with one or more of the first through seventh aspects, each UE included in the first set of UEs associated with the base station includes a RACH capability, and each UE included in the second set of UEs associated with the base station does not include a RACH capability.

In a ninth aspect, alone or in combination with one or more of the first through eighth aspects, the spreading code is a Walsh code, or a discrete Fourier transform based spreading code.

In a tenth aspect, alone or in combination with one or more of the first through ninth aspects, process 900 includes determining that the spreading code is a discrete Fourier transform based spreading code when a quantity of repetitions of a PRACH preamble included in the PRACH communication is an odd value.

In an eleventh aspect, alone or in combination with one or more of the first through tenth aspects, process 900 includes determining that the spreading code is a Walsh code when a quantity of repetitions of a PRACH preamble included in the PRACH communication is an even value.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

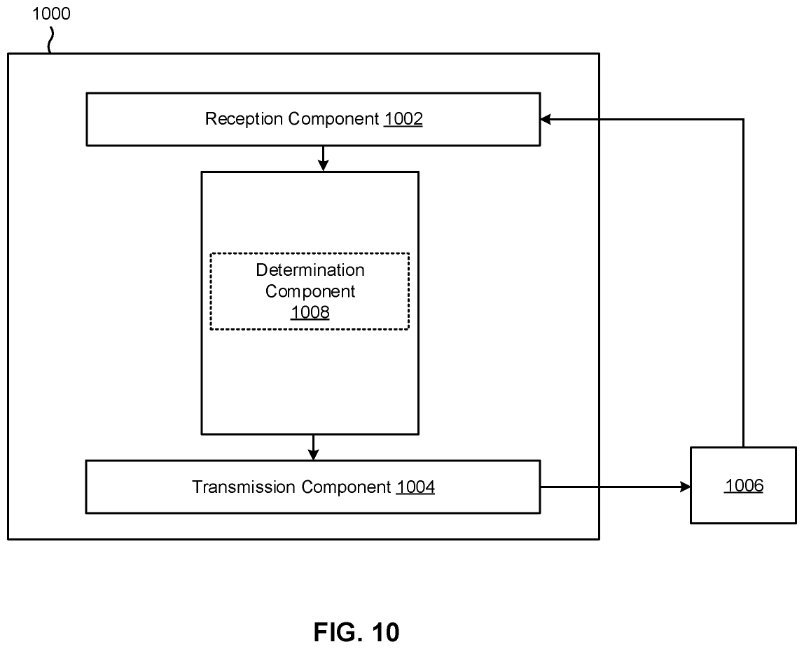

FIG. 10 is a diagram illustrating an example apparatus 1000 for wireless communication, in accordance with the present disclosure. The apparatus 1000 may be a UE, or a UE may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as another UE, a base station, or another wireless communication device) using the reception component 1002 and the transmission component 1004. As further shown, the apparatus 1000 may include one or more of a determination component 1008, among other examples.

In some aspects, the apparatus 1000 may be configured to perform one or more operations described herein in connection with FIG. 7. Additionally or alternatively, the apparatus 1000 may be configured to perform one or more processes described herein, such as process 800 of FIG. 8, or a combination thereof. In some aspects, the apparatus 1000 and/or one or more components shown in FIG. 10 may include one or more components of the user equipment described above in connection with FIG. 2. Additionally, or alternatively, one or more components shown in FIG. 10 may be implemented within one or more components described above in connection with FIG. 2. Additionally or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1006. In some aspects, the reception component 1002 may include one or more antennas, a demodulator, a MIMO detector, a receive processor, a controller/processor, a memory, or a combination thereof, of the user equipment described above in connection with FIG. 2.

The transmission component 1004 may transmit communications, such as reference signals, control information, data communications, or a combination thereof, to the apparatus 1006. In some aspects, one or more other components of the apparatus 1006 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modulator, a transmit MIMO processor, a transmit processor, a controller/processor, a memory, or a combination thereof, of the user equipment described above in connection with FIG. 2. In some aspects, the transmission component 1004 may be collocated with the reception component 1002 in a transceiver.

The reception component 1002 may receive, from a base station, a random access configuration indicating spreading code information for a set of RACH occasions associated with a RACH procedure. The transmission component 1004 may transmit, to the base station, a physical RACH (PRACH) communication in a RACH occasion, of the set of RACH occasions, using a spreading code. The determination component 1008 may determine the spreading code associated with the PRACH communication from the spreading code information.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally or alternatively, a set of (one or more) components shown in FIG. 10 may perform one or more functions described as being performed by another set of components shown in FIG. 10.

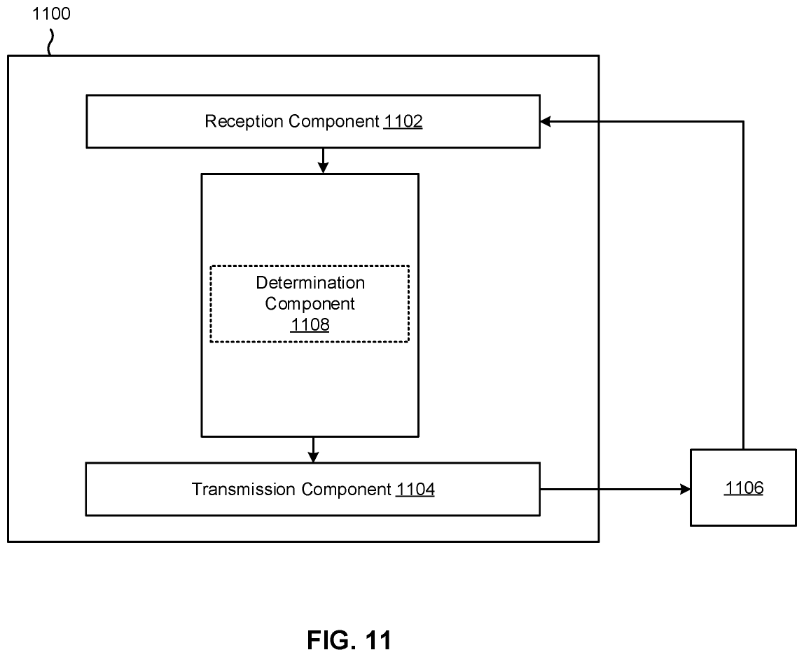

FIG. 11 is a diagram illustrating an example apparatus 1100 for wireless communication, in accordance with the present disclosure. The apparatus 1100 may be a base station, or a base station may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a base station, or another wireless communication device) using the reception component 1102 and the transmission component 1104. As further shown, the apparatus 1100 may include one or more of a determination component 1108, among other examples.

In some aspects, the apparatus 1100 may be configured to perform one or more operations described herein in connection with FIG. 7. Additionally or alternatively, the apparatus 1100 may be configured to perform one or more processes described herein, such as process 900 of FIG. 9, or a combination thereof. In some aspects, the apparatus 1100 and/or one or more components shown in FIG. 11 may include one or more components of the base station described above in connection with FIG. 2. Additionally, or alternatively, one or more components shown in FIG. 11 may be implemented within one or more components described above in connection with FIG. 2. Additionally or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1106. In some aspects, the reception component 1102 may include one or more antennas, a demodulator, a MIMO detector, a receive processor, a controller/processor, a memory, or a combination thereof, of the base station described above in connection with FIG. 2.

The transmission component 1104 may transmit communications, such as reference signals, control information, data communications, or a combination thereof, to the apparatus 1106. In some aspects, one or more other components of the apparatus 1106 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modulator, a transmit MIMO processor, a transmit processor, a controller/processor, a memory, or a combination thereof, of the base station described above in connection with FIG. 2. In some aspects, the transmission component 1104 may be collocated with the reception component 1102 in a transceiver.

The transmission component 1104 may transmit, to one or more UEs, a random access configuration indicating spreading code information for a set of RACH occasions associated with a RACH procedure. The reception component 1102 may receive, from a UE of the one or more UEs, a PRACH communication in a RACH occasion, of the set of RACH occasions, using a spreading code, wherein the spreading code is determined based at least in part on the spreading code information. The determination component 1108 may determine the spreading code information for the set of RACH occasions associated with the RACH procedure based at least in part on a validity of RACH occasions, included in the set of RACH occasions, for a set of UEs associated with the base station.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally or alternatively, a set of (one or more) components shown in FIG. 11 may perform one or more functions described as being performed by another set of components shown in FIG. 11.

The following provides an overview of some Aspects of the present disclosure:

Aspect 1: A method of wireless communication performed by a user equipment (UE), comprising: receiving, from a base station, a random access configuration indicating spreading code information for a set of random access channel (RACH) occasions associated with a RACH procedure; and transmitting, to the base station, a physical RACH (PRACH) communication in a RACH occasion, of the set of RACH occasions, using a spreading code, wherein the spreading code is determined based at least in part on the spreading code information.

Aspect 2: The method of Aspect 1, further comprising: determining the spreading code associated with the PRACH communication from the spreading code information based at least in part on at least one of: the RACH occasion, of the set of RACH occasions, associated with the PRACH communication, a quantity of repetitions of a PRACH preamble included in the PRACH communication, or a RACH capability of the UE.

Aspect 3: The method of any of Aspects 1-2, wherein the spreading code information for the set of RACH occasions associated with the RACH procedure indicates at least one of: a first spreading code for a first subset of RACH occasions, of the set of RACH occasions, that are valid for each UE associated with the base station; a second spreading code for a second subset of RACH occasions, of the set of RACH occasions, that are valid only for a proper subset of UEs associated with the base station; or a third spreading code for a third subset of RACH occasions, of the set of RACH occasions, that are valid for the proper subset of UEs associated with the base station.

Aspect 4: The method of Aspect 3, wherein the proper subset of UEs associated with the base station is determined based at least in part on a RACH capability of UEs included in the proper subset of UEs.

Aspect 5: The method of any of Aspects 1-4, further comprising: determining, from the spreading code information, the spreading code based at least in part on a quantity of repetitions of a PRACH preamble included in the PRACH communication.

Aspect 6: The method of any of Aspects 1-5, further comprising: determining, from the spreading code information, that the spreading code is a nested spreading code based at least in part on a quantity of repetitions of a PRACH preamble included in the PRACH communication.

Aspect 7: The method of any of Aspects 1-6, wherein receiving, from the base station, the random access configuration indicating the spreading code information for the set of RACH occasions associated with the RACH procedure comprises: receiving, from the base station, the random access configuration indicating a set of PRACH preambles, wherein the set of PRACH preambles include one or more subsets of PRACH preambles.

Aspect 8: The method of Aspect 7, wherein a subset of PRACH preambles, of the set of PRACH preambles, is associated with: a quantity of repetitions of a PRACH preamble included in the PRACH communication, or a RACH capability of the UE.

Aspect 9: The method of any of Aspects 7-8, wherein the one or more subsets of PRACH preambles include: a first subset of PRACH preambles associated with a first set of UEs associated with the base station, and a second subset of PRACH preambles associated with a second set of UEs associated with the base station.

Aspect 10: The method of any of Aspects 1-9, wherein the spreading code is: a Walsh code, or a discrete Fourier transform based spreading code.

Aspect 11: The method of any of Aspects 1-10, further comprising: determining that a quantity of repetitions of a PRACH preamble included in the PRACH communication is an even value; and determining that the spreading code is a Walsh code.

Aspect 12: The method of any of Aspects 1-11, further comprising: determining that a quantity of repetitions of a PRACH preamble included in the PRACH communication is an odd value; and determining that the spreading code is a discrete Fourier transform based spreading code.

Aspect 13: A method of wireless communication performed by a base station, comprising: transmitting, to one or more user equipment (UEs), a random access configuration indicating spreading code information for a set of random access channel (RACH) occasions associated with a RACH procedure; and receiving, from a UE of the one or more UEs, a physical RACH (PRACH) communication in a RACH occasion, of the set of RACH occasions, using a spreading code, wherein the spreading code is determined based at least in part on the spreading code information.

Aspect 14: The method of Aspect 13, further comprising: determining the spreading code information for the set of RACH occasions associated with the RACH procedure based at least in part on a validity of RACH occasions, included in the set of RACH occasions, for a set of UEs associated with the base station.

Aspect 15: The method of Aspect 14, wherein determining the spreading code information for the set of RACH occasions associated with the RACH procedure comprises determining at least one of: a first spreading code for a first subset of RACH occasions, of the set of RACH occasions, that are valid for each UE of the set of UEs associated with the base station; a second spreading code for a second subset of RACH occasions, of the set of RACH occasions, that are valid only for a subset of UEs of the set of UEs associated with the base station; or a third spreading code for a third subset of RACH occasions, of the set of RACH occasions, that are valid for the subset of UEs of the set of UEs associated with the base station.

Aspect 16: The method of Aspect 15, further comprising: determining the subset of UEs, of the set of UEs associated with the base station, based at least in part on a RACH capability of UEs included in the subset of UEs.

Aspect 17: The method of any of Aspects 14-16, wherein determining the spreading code information for the set of RACH occasions associated with the RACH procedure comprises: determining a spreading code to be applied to PRACH communications based at least in part on a quantity of repetitions of a PRACH preamble included in the PRACH communications.

Aspect 18: The method of any of Aspects 14-17, wherein determining the spreading code information for the set of RACH occasions associated with the RACH procedure comprises: determining a nested spreading code to be applied to PRACH communications based at least in part on a quantity of repetitions of a PRACH preamble included in the PRACH communications.

Aspect 19: The method of any of Aspects 13-18, further comprising: determining, from a set of PRACH preambles, one or more subsets of PRACH preambles based at least in part on: a quantity of repetitions of a PRACH preamble, of the set of PRACH preambles, to be included in PRACH communications, or a RACH capability of UEs associated with the base station.

Aspect 20: The method of Aspect 19, wherein determining, from the set of PRACH preambles, the one or more subsets of PRACH preambles comprises: determining a first subset of PRACH preambles associated with a first set of UEs associated with the base station; and determining a second subset of PRACH preambles associated with a second set of UEs associated with the base station.

Aspect 21: The method of Aspect 20, wherein each UE included in the first set of UEs associated with the base station includes a RACH capability, and wherein each UE included in the second set of UEs associated with the base station does not include a RACH capability.

Aspect 22: The method of any of Aspects 13-21, wherein the spreading code is: a Walsh code, or a discrete Fourier transform based spreading code.

Aspect 23: The method of any of Aspects 13-22, further comprising: determining that the spreading code is a discrete Fourier transform based spreading code when a quantity of repetitions of a PRACH preamble included in the PRACH communication is an odd value.

Aspect 24: The method of any of Aspects 13-23, further comprising: determining that the spreading code is a Walsh code when a quantity of repetitions of a PRACH preamble included in the PRACH communication is an even value.

Aspect 25: An apparatus for wireless communication at a device, comprising a processor; memory coupled with the processor; and instructions stored in the memory and executable by the processor to cause the apparatus to perform the method of one or more of Aspects 1-12.

Aspect 26: A device for wireless communication, comprising a memory and one or more processors coupled to the memory, the one or more processors configured to perform the method of one or more of Aspects 1-12.

Aspect 27: An apparatus for wireless communication, comprising at least one means for performing the method of one or more of Aspects 1-12.

Aspect 28: A non-transitory computer-readable medium storing code for wireless communication, the code comprising instructions executable by a processor to perform the method of one or more of Aspects 1-12.

Aspect 29: A non-transitory computer-readable medium storing a set of instructions for wireless communication, the set of instructions comprising one or more instructions that, when executed by one or more processors of a device, cause the device to perform the method of one or more of Aspects 1-12.

Aspect 30: An apparatus for wireless communication at a device, comprising a processor; memory coupled with the processor; and instructions stored in the memory and executable by the processor to cause the apparatus to perform the method of one or more of Aspects 13-24.

Aspect 31: A device for wireless communication, comprising a memory and one or more processors coupled to the memory, the one or more processors configured to perform the method of one or more of Aspects 13-24.

Aspect 32: An apparatus for wireless communication, comprising at least one means for performing the method of one or more of Aspects 13-24.

Aspect 33: A non-transitory computer-readable medium storing code for wireless communication, the code comprising instructions executable by a processor to perform the method of one or more of Aspects 13-24.

Aspect 34: A non-transitory computer-readable medium storing a set of instructions for wireless communication, the set of instructions comprising one or more instructions that, when executed by one or more processors of a device, cause the device to perform the method of one or more of Aspects 13-24.

The foregoing disclosure provides illustration and description, but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a processor is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method of wireless communication performed by a user equipment (UE), comprising:
receiving, from a base station, a random access configuration indicating spreading code information for a set of random access channel (RACH) occasions associated with a RACH procedure; and
transmitting, to the base station, a physical RACH (PRACH) communication in a RACH occasion, of the set of RACH occasions, using a spreading code, wherein the spreading code is determined based at least in part on the spreading code information.

2. The method of claim 1, further comprising:
determining the spreading code associated with the PRACH communication from the spreading code information based at least in part on at least one of:
the RACH occasion, of the set of RACH occasions, associated with the PRACH communication,
a quantity of repetitions of a PRACH preamble included in the PRACH communication, or
a RACH capability of the UE.

3. The method of claim 1, wherein the spreading code information for the set of RACH occasions associated with the RACH procedure indicates at least one of:
a first spreading code for a first subset of RACH occasions, of the set of RACH occasions, that are valid for each UE associated with the base station;
a second spreading code for a second subset of RACH occasions, of the set of RACH occasions, that are valid only for a proper subset of UEs associated with the base station; or
a third spreading code for a third subset of RACH occasions, of the set of RACH occasions, that are valid for the proper subset of UEs associated with the base station.

4. The method of claim 3, wherein the proper subset of UEs associated with the base station is determined based at least in part on a RACH capability of UEs included in the proper subset of UEs.

5. The method of claim 1, further comprising:
determining, from the spreading code information, the spreading code based at least in part on a quantity of repetitions of a PRACH preamble included in the PRACH communication.

6. The method of claim 1, further comprising:
determining, from the spreading code information, that the spreading code is a nested spreading code based at least in part on a quantity of repetitions of a PRACH preamble included in the PRACH communication.

7. The method of claim 1, wherein receiving, from the base station, the random access configuration indicating the spreading code information for the set of RACH occasions associated with the RACH procedure comprises:
receiving, from the base station, the random access configuration indicating a set of PRACH preambles, wherein the set of PRACH preambles include one or more subsets of PRACH preambles.

8. The method of claim 7, wherein a subset of PRACH preambles, of the set of PRACH preambles, is associated with:
a quantity of repetitions of a PRACH preamble included in the PRACH communication, or
a RACH capability of the UE.

9. The method of claim 7, wherein the one or more subsets of PRACH preambles include:
a first subset of PRACH preambles associated with a first set of UEs associated with the base station, and
a second subset of PRACH preambles associated with a second set of UEs associated with the base station.

10. The method of claim 1, further comprising:
determining that a quantity of repetitions of a PRACH preamble included in the PRACH communication is an even value; and
determining that the spreading code is a Walsh code.

11. The method of claim 1, further comprising:
determining that a quantity of repetitions of a PRACH preamble included in the PRACH communication is an odd value; and
determining that the spreading code is a discrete Fourier transform based spreading code.

12. A user equipment (UE) for wireless communication, comprising:
a memory; and
one or more processors, coupled to the memory, configured to:
receive, from a base station, a random access configuration indicating spreading code information for a set of random access channel (RACH) occasions associated with a RACH procedure; and
transmit, to the base station, a physical RACH (PRACH) communication in a RACH occasion, of the set of RACH occasions, using a spreading code, wherein the spreading code is determined based at least in part on the spreading code information.

13. The UE of claim 12, wherein the one or more processors are further configured to:
determine the spreading code associated with the PRACH communication from the spreading code information based at least in part on at least one of:
the RACH occasion, of the set of RACH occasions, associated with the PRACH communication,
a quantity of repetitions of a PRACH preamble included in the PRACH communication, or
a RACH capability of the UE.

14. The UE of claim 12, wherein the spreading code information for the set of RACH occasions associated with the RACH procedure indicates at least one of:
a first spreading code for a first subset of RACH occasions, of the set of RACH occasions, that are valid for each UE associated with the base station;
a second spreading code for a second subset of RACH occasions, of the set of RACH occasions, that are valid only for a proper subset of UEs associated with the base station; or
a third spreading code for a third subset of RACH occasions, of the set of RACH occasions, that are valid for the proper subset of UEs associated with the base station.

15. The UE of claim 14, wherein the proper subset of UEs associated with the base station is determined based at least in part on a RACH capability of UEs included in the proper subset of UEs.

16. The UE of claim 12, wherein the one or more processors are further configured to:
determine, from the spreading code information, the spreading code based at least in part on a quantity of repetitions of a PRACH preamble included in the PRACH communication.

17. The UE of claim 12, wherein the one or more processors are further configured to:
determine, from the spreading code information, that the spreading code is a nested spreading code based at least in part on a quantity of repetitions of a PRACH preamble included in the PRACH communication.

18. The UE of claim 12, wherein the one or more processors, to receive, from the base station, the random access configuration indicating the spreading code information for the set of RACH occasions associated with the RACH procedure, are configured to:
receive, from the base station, the random access configuration indicating a set of PRACH preambles, wherein the set of PRACH preambles include one or more subsets of PRACH preambles.

19. The UE of claim 18, wherein a subset of PRACH preambles, of the set of PRACH preambles, is associated with:
a quantity of repetitions of a PRACH preamble included in the PRACH communication, or
a RACH capability of the UE.

20. The UE of claim 18, wherein the one or more subsets of PRACH preambles include:
a first subset of PRACH preambles associated with a first set of UEs associated with the base station, and
a second subset of PRACH preambles associated with a second set of UEs associated with the base station.

21. The UE of claim 12, wherein the one or more processors are further configured to:
determine that a quantity of repetitions of a PRACH preamble included in the PRACH communication is an even value; and
determine that the spreading code is a Walsh code.

22. The UE of claim 12, wherein the one or more processors are further configured to:
determine that a quantity of repetitions of a PRACH preamble included in the PRACH communication is an odd value; and
determine that the spreading code is a discrete Fourier transform based spreading code.

23. A method of wireless communication performed by a base station, comprising:
transmitting, to one or more user equipment (UEs), a random access configuration indicating spreading code information for a set of random access channel (RACH) occasions associated with a RACH procedure; and
receiving, from a UE of the one or more UEs, a physical RACH (PRACH) communication in a RACH occasion, of the set of RACH occasions, using a spreading code, wherein the spreading code is determined based at least in part on the spreading code information.

24. The method of claim 23, further comprising:
determining the spreading code information for the set of RACH occasions associated with the RACH procedure based at least in part on a validity of RACH occasions, included in the set of RACH occasions, for a set of UEs associated with the base station.

25. The method of claim 24, wherein determining the spreading code information for the set of RACH occasions associated with the RACH procedure comprises determining at least one of:
a first spreading code for a first subset of RACH occasions, of the set of RACH occasions, that are valid for each UE of the set of UEs associated with the base station;
a second spreading code for a second subset of RACH occasions, of the set of RACH occasions, that are valid only for a subset of UEs of the set of UEs associated with the base station; or
a third spreading code for a third subset of RACH occasions, of the set of RACH occasions, that are valid for the subset of UEs of the set of UEs associated with the base station.

26. The method of claim 23, further comprising:
determining, from a set of PRACH preambles, one or more subsets of PRACH preambles based at least in part on:
a quantity of repetitions of a PRACH preamble, of the set of PRACH preambles,
to be included in PRACH communications, or
a RACH capability of UEs associated with the base station.

27. A base station for wireless communication, comprising:
a memory; and
one or more processors, coupled to the memory, configured to:
transmit, to one or more user equipment (UEs), a random access configuration indicating spreading code information for a set of random access channel (RACH) occasions associated with a RACH procedure; and
receive, from a UE of the one or more UEs, a physical RACH (PRACH) communication in a RACH occasion, of the set of RACH occasions, using a spreading code, wherein the spreading code is determined based at least in part on the spreading code information.

28. The base station of claim 27, wherein the one or more processors are further configured to:
determine the spreading code information for the set of RACH occasions associated with the RACH procedure based at least in part on a validity of RACH occasions, included in the set of RACH occasions, for a set of UEs associated with the base station.

29. The base station of claim 28, wherein the one or more processors, to determine the spreading code information for the set of RACH occasions associated with the RACH procedure, are configured to determine at least one of:
a first spreading code for a first subset of RACH occasions, of the set of RACH occasions, that are valid for each UE of the set of UEs associated with the base station;
a second spreading code for a second subset of RACH occasions, of the set of RACH occasions, that are valid only for a subset of UEs of the set of UEs associated with the base station; or
a third spreading code for a third subset of RACH occasions, of the set of RACH occasions, that are valid for the subset of UEs of the set of UEs associated with the base station.

30. The base station of claim 27, wherein the one or more processors are further configured to:
determine, from a set of PRACH preambles, one or more subsets of PRACH preambles based at least in part on:
a quantity of repetitions of a PRACH preamble, of the set of PRACH preambles, to be included in PRACH communications, or
a RACH capability of UEs associated with the base station.
